(19) United States
(12) Patent Application Publication
(10) Pub. No.: US 2005/0174788 A1
(43) Pub. Date: Aug. 11, 2005

(54) High intensity lamp system for a motorcycle

(75) Inventors: Roger A. Hood, Lockport, NY (US); David Thomas Somerwill, Cincinnati, OH (US)

Correspondence Address: Neal L. Slifkin, 99 Garnsey Road, Pittsford, NY, 14534, US

(73) Assignee: Niagara Precision, Inc.

(21) Appl. No.: 11/046,253

(22) Filed: Jan. 28, 2005

Related U.S. Application Data
(60) Provisional application No. 60/540,928, filed on Jan. 30, 2004.

(51) Int. Cl. F21V 33/00

(52) U.S. Cl. 362/475; 362/476

(57) ABSTRACT

A high intensity lamp system for a motorcycle incorporating a plurality of commercially available integral reflector halogen lamps within a crossmember element of a motorcycle triple tree assembly. A control system continually adjusts the power delivered to the lamps to maintain safe operating temperature to maximize bulb life at light intensity levels consistent with vehicular applications for headlighting applications. This is achieved using lamps not intended for sealed operation and the high shock and vibration environment of a vehicular or motorcycle application. A microprocessor-based digital control system of the preferred embodiment permits additional control and continual adjustment of lamp power to eliminate visible dimming of the lamps dependant on engine speed and state of the vehicle charging system, which dimming is evident in prior art use of high intensity lamps operating at light output levels reduced from maximum ratings for bulb life considerations.

### RELATIONSHIP TO OTHER APPLICATIONS AND PATENTS

This Application draws priority from a pending U.S. Provisional Application Ser. No. 60/540,928, filed Jan. 30, 2004.

### TECHNICAL FIELD

The present invention relates to motorcycles; more particularly, to headlight means for a motorcycle; and most particularly, to method and apparatus for mounting and operating commercially available high-intensity lamps within a motorcycle triple tree crossmember to provide headlight operation within safe operating limits and acceptable lamp life.

### BACKGROUND OF THE INVENTION

It is known in the art of motorcycle headlight design to provide for a variety of streamline shapes for a motorcycle headlight housing and faring in conjunction with the so-called “triple tree” arrangement wherein a steering fork is pivotably mounted to a motorcycle frame, defining a steering head. See, for example, U.S. Pat. Nos. D374,730; D423,126; and D495,815S. Further, in some applications it is desired for style and/or speed purposes that the relatively large headlight and associated housing of a conventional prior art motorcycle headlight assembly be completely eliminated, as by embedding of a headlight function within a vehicle's structural members which provides the look and line as if there were no headlight at all, yet the headlight function is retained in a position and location ideal for headlight performance.

Commercially available high intensity lamps, such as integral reflector halogen lamps, can provide high levels of light output consistent with requirements for vehicular headlights in a relatively small volume and form factor. Such lamps, having integral polished reflectors, can provide shaped beams in 10 to 20 degree angle spotlight configurations that are well-suited to vehicular headlight applications.

High intensity halogen lamps in a motorcycle application are subject to high power density and thermal dissipation limitations and to a shock/vibration environment for which commercially available, integral reflector halogen lamps are not intended nor inherently well-suited. Such lamps are designed and intended for use in residential/commercial interior lighting applications with constant available power, adequate ventilation for cooling, and low-shock environment. Experience has shown that operation of such halogen lamps at their fully specified light output levels and power input ratings in a sealed, vehicular environment results in an unacceptably shortened bulb life and consequent failure.

What is needed in the art of motorcycle headlights is an arrangement wherein a conventional large and obvious headlight housing is obviated.

What is further needed in the art of motorcycle headlights is a halogen lamp system having high reliability, long lifetime, and constant light output under all operating conditions.

It is a primary object of the invention to eliminate a conventional large and obvious headlight housing from a motorcycle assembly.

It is a further object of the invention to provide a compact motorcycle headlight system having high reliability, long lifetime, and constant light output under all operating conditions.

### SUMMARY OF THE INVENTION

Briefly described, a motorcycle headlight system in accordance with the invention comprises a plurality of reflector-type halogen lamps disposed in a housing formed as a triple tree crossmember of a motorcycle (also referred to herein simply as a “triple tree” as is well known in the motorcycle arts).

High beam and low beam headlight operation are on/off controlled by conventional handlebar mounted switches.

Control circuitry extends lamp lifetime by operating the lamps at less than full power ratings. A desired light output level for a vehicular headlight is obtained by using a plurality of lamps, all being operated at derated power levels. An automatic control circuit for safe operation of multiple lamps in derated mode over wide ambient temperature ranges and input supply voltages is provided to achieve long bulb life and light output performance expected of typical vehicular headlights. By applying a pulse width modulated (PWM) control signal, the average current and thus average power can be controlled to maintain acceptable headlight intensity and color temperature. PWM switching is performed at a rate far faster than the response time of the bulb filaments such that no perceptible flicker occurs from the pulsed control waveform.

The control PWM generator accepts a temperature sensing element input from a thermistor or similar resistance varying element over ambient temperature. The temperature sensing element is mounted in proximity to the lamp heat source and circuitry most susceptible to damage due to excess temperatures. The sensor generates an error voltage and the PWM generator proportionally reduces the duty cycle of the control signal to maintain the assembly at or below the safe operating temperature. In the event the internal temperature falls, due, for example, to better heat dissipation resulting from increased windspeed around the housing or night operation in the absence of solar thermal loading, the PWM generator proportionally increases the duty cycle to achieve maximum permissible power and headlight output.

The halogen control assembly has an under/over supply voltage sensor detecting the difference from the nominal 12 vdc supply and applies this error to the PWM generator. By applying a reduced duty cycle waveform to the control switches proportional to the overvoltage error, the halogen lamps can be operated safely in the expected, naturally occurring overvoltage conditions of high engine speed and a fully charged battery. Conversely, an undervoltage error signal results in a higher duty cycle from the PWM generator to prevent annoying headlight yellowing at low engine speed.

### BRIEF DESCRIPTION OF THE DRAWINGS

The present invention will now be described, by way of example, with reference to the accompanying drawings, in which:

FIG. 1 is an isometric view of a prior art motorcycle headlamp housing for attachment to a triple tree crossmember;

FIG. 2 is an isometric view from below of a motorcycle steering head showing a triple tree crossmember containing headlamps in accordance with the invention;

FIG. 3 is an isometric view from above of the steering head shown in FIG. 2;

FIG. 4 is an isometric view from the left side of the steering head shown in FIGS. 2 and 3;

FIG. 5 is a plan view from above of a triple tree crossmember in accordance with the invention;

FIG. 6 is a plan view from below of the triple tree crossmember shown in FIG. 5;

FIG. 7 is a front elevational view of the triple tree crossmember shown in FIGS. 5 and 6;

FIG. 8 is an cross-sectional view taken along line 8-8 in FIG. 7;

FIG. 8a is an exploded isometric view of a triple tree crossmember assembly in accordance with the invention;

FIG. 9 is a block diagram of a function for controlling a headlight system in accordance with the invention; and

FIG. 10 is a schematic electrical diagram of the headlight system.

### DESCRIPTION OF THE PREFERRED EMBODIMENTS

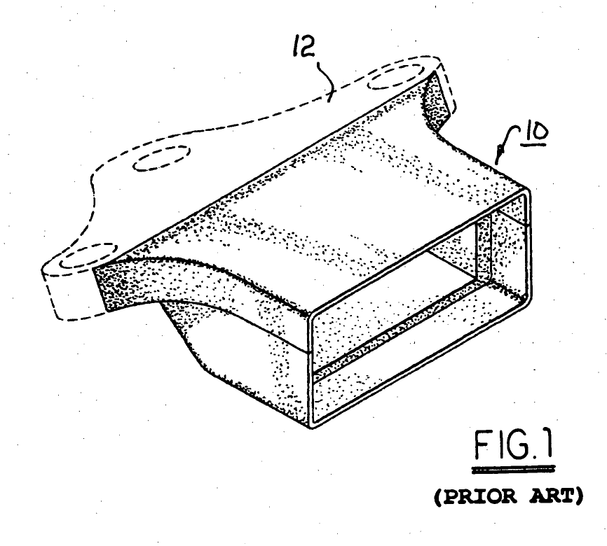

Referring to FIG. 1, a prior art headlight housing 10 for mounting adjacent to a prior art motorcycle triple tree 12 is shown, substantially as disclosed in U.S. Pat. No. Des. 374,730, issued Oct. 15, 1996 to Hauser. Housing 10 clearly demonstrates the benefit of a headlight mounting that is positioned by a triple tree crossmember, but housing 10 still presents a bulky and protrusive form for carrying a headlight well ahead of and sdeparate from the triple tree. Further, this design patent is silent as to the type and number of lamps for which the housing is suitable. Housing 10 does not suggest the benefit of forming the triple tree crossmember itself as a housing for one or more miniature high-intensity lamps and control circuitry, as is novelly described and claimed herein.

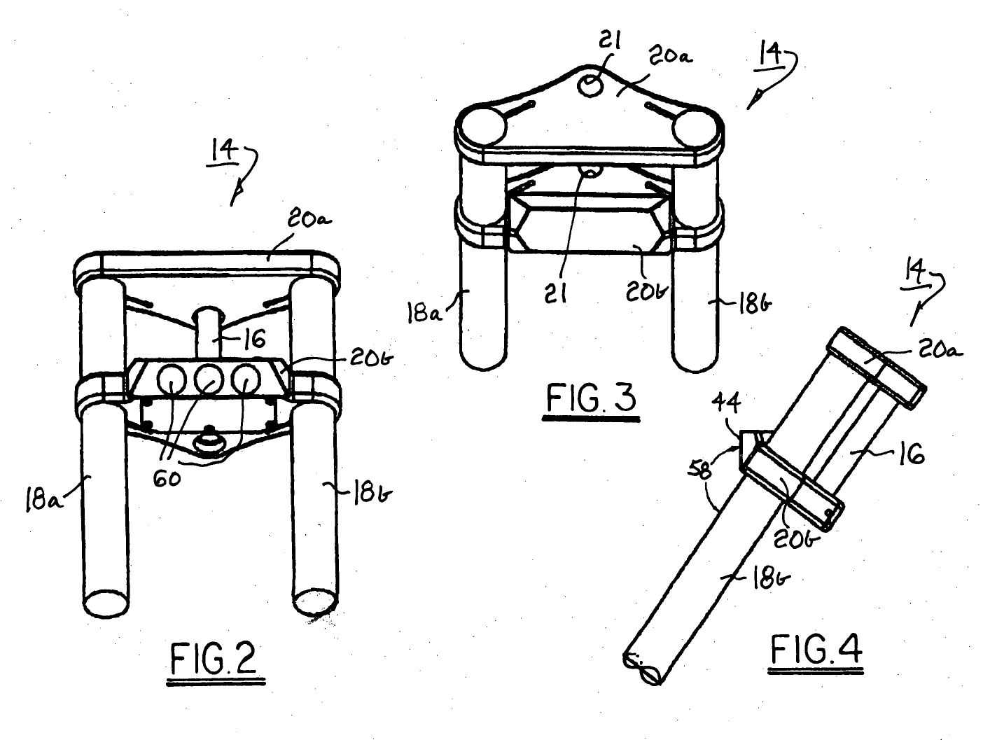

Referring to FIGS. 2 through 4, a steering head 14, in accordance with the invention, for a motorcycle (not shown) defines a pivot post 16 fixedly disposed on the motorcycle, right and left steering fork tubes 18a,18b, and one or more triple trees, preferably two spaced apart vertically as triple trees 20a,20b, pivotably connecting the steering fork tubes to the pivot post via openings 21. Preferably, both triple trees are provided with bearings 24 (FIGS. 6,8) in known fashion in openings 22a, 22b for smooth, durable steering rotation of the triple trees on the pivot post.

Referring to FIGS. 5 through 8a, lower triple tree 20b in accordance with the invention is formed of a strong, lightweight material such as aluminum, titanium, or other metal or metal alloy, or an organic polymer. Triple tree 20b is so formed as to function structurally as a conventional triple tree crossmember and also as a housing for one or more headlamps 28. Lateral portions of triple tree 20b comprise left and right mounting clamps 30a, 30b having openings 32a, 32b for receiving fork tubes 18a, 18b. Each clamp includes a compression allowance slot 34a, 34b and compression screws 36a, 36b threaded into bores to permit secure tightening of triple tree 20b onto the fork tubes at any desired location along the tubes, consistent with the length of pivot post 16.

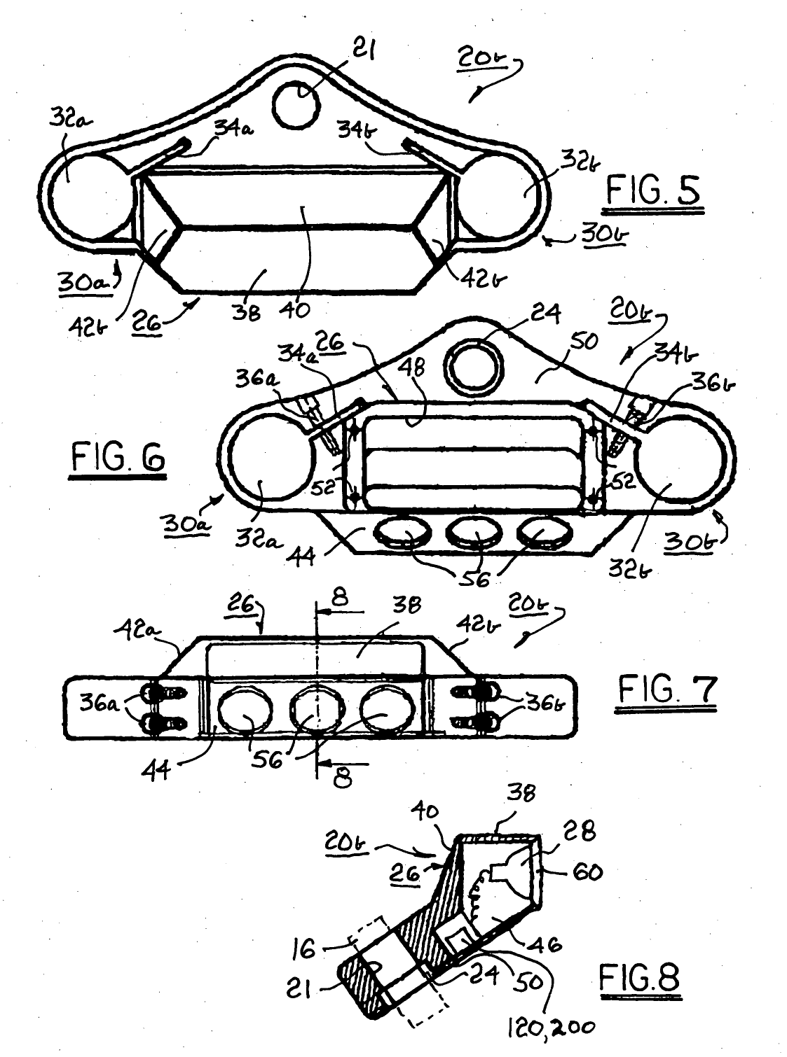

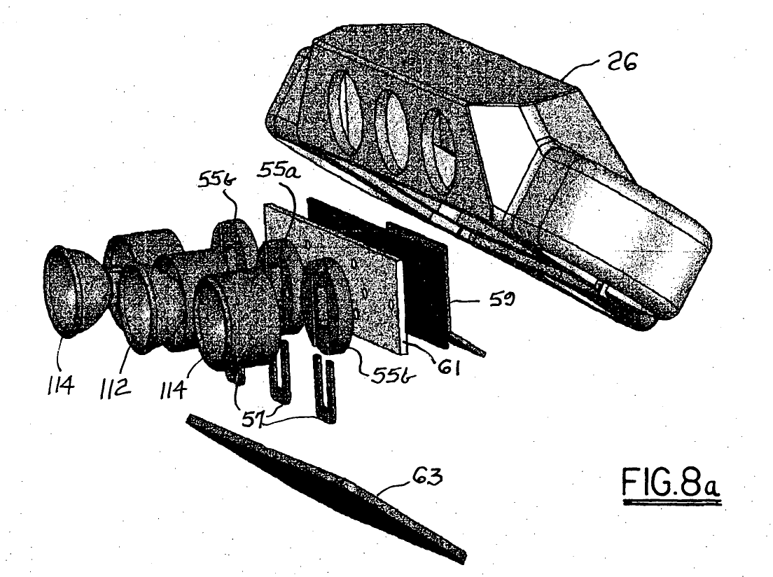

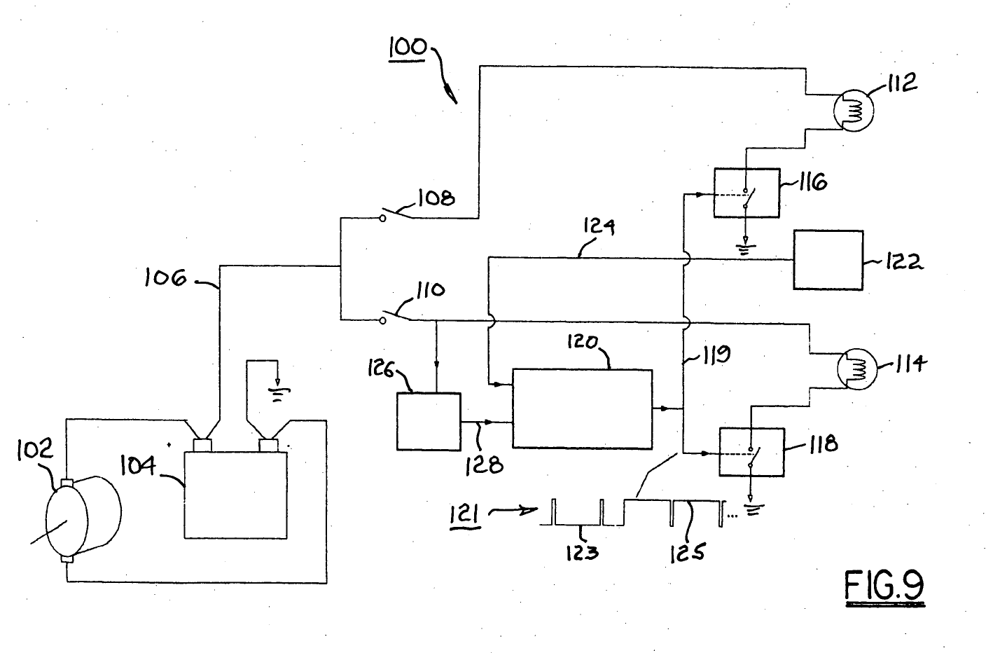

A housing 26 is formed centrally of triple tree 20b comprising a top wall 38, rear wall 40, side walls 42a, 42b, and a front wall 44, and enclosing a chamber 46. Chamber 46 is open 48 on an underside 50 of triple tree 20b. In use, opening 48 is hermetically sealed via a cover plate 63 (FIG. 8a) secured by bolts (not shown) in bores 52.

In the currently-preferred embodiment 20b shown in FIGS. 2 through 8a, within chamber 46 are a microprocessor 120 and associated control cuircuitry 200 for controlling operation of one or more lamps 28. Lamp 28 comprises first and second low-beam lamps 114 disposed on either side of a central high-beam lamp 112, the lamps being positioned within chamber 46 adjacent to ports 56 in front wall 44. Housing 26 is formed such that front wall 44 forms an angle 58 (FIG. 4) with the walls of openings 32a, 32b such that wall 44 is substantially vertical when the triple tree is installed for use on the forks and pivot post of a motorcycle. Preferably, each port 56 is closed by a shatter-proof lens element 60 to protect lamps 112, 114. Preferably, high beam lamp 112 is mounted in housing 26 such that the axis of the beam extending through lens 60 is substantially parallel in use to a road surface; low-beam lamps 114 preferably are depressed by about 2 degrees with respect to the high beam lamp. As described above, each lamp 28 is preferably a commercially available integral reflector halogen lamp although other types of lamps are fully comprehended by the invention.

Each lamp 112, 114 is supported by a light can 54 and extends through an opening in a shim plate 55 to which it is locked by a lock plate 57. Shim plate 55a for high-beam lamp 112 contains 0o wedge, while shim plates 55b contain a 2o vertical wedge. A mounting plate 59 secures the internal lamp assembly to housing 26, and an insulator plate 61 shields microprocessor 120 and circuitry 200 from the heat of the lamps. Cover plate 63 closes chamber 46 as described above.

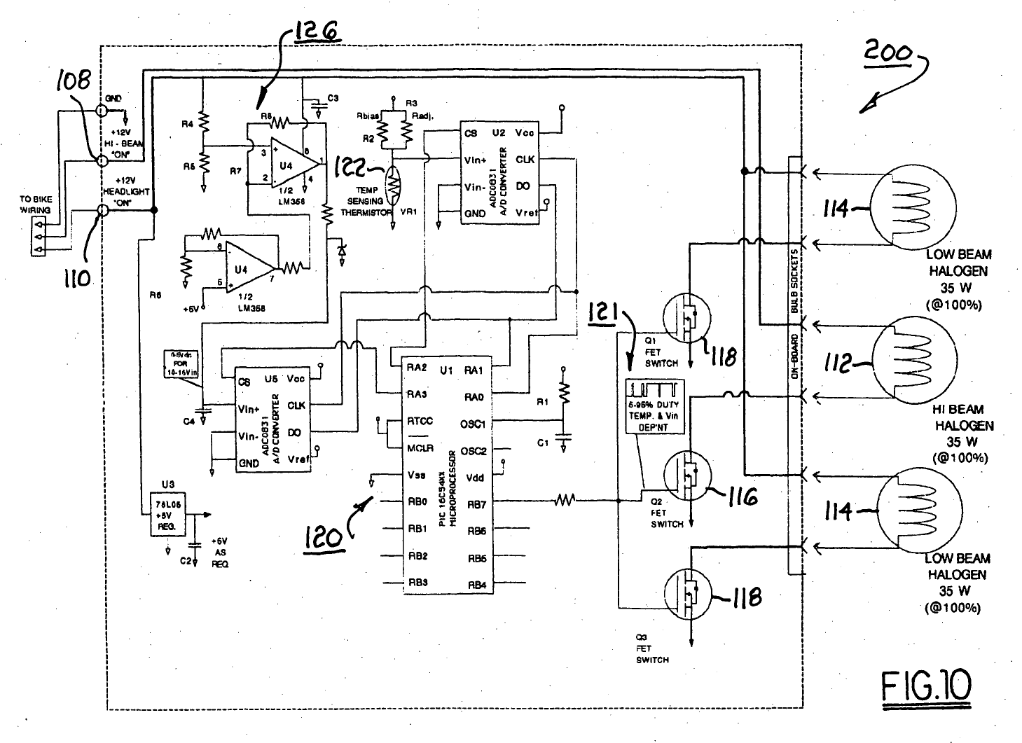

Referring to FIG. 9, a control function for a motorcycle headlight system in accordance with the invention is shown in block diagram 100. This control function, although shown here exemplarily for a motorcycle headlight system, is suitable for use with any halogen-type lamp system wherein a constant color temperature and lamp intensity are desired over a range of electrical and thermal conditions.

A conventional motorcycle 12-volt charging system 102 and a 12-volt battery 104 provide nominal 12-volt current 106 to high-beam switch 108 and low-beam switch 110, which may be separate switches or a toggle switch. The switches control one or more high-beam lamps 112 and one or more low-beam lamps 114, respectively. The lamps are preferably high-intensity halogen lamps as described above. Preferably, all lamps are identical, and high-beam and low-beam refer only to the angle the lamp forms with the roadway surface, as just described.

Lamps 112, 114 are grounded through first and second FET electronic switches 116, 118, respectively. Switches 116, 118 are controlled by a microprocessor 120 and associated circuitry as described below (FIG. 10), including a pulse width modulated (PWM) control generator which generates an output signal 119 to open and close on a specified duty cycle 121, variable by microprocessor 120 between 5% 123 and 95% 125, whereby any lamps whose switches 116, 118 are closed are pulsed at a high frequency, as described below. Because the lamps generate heat that can be detrimental to lamp life, a temperature sensing element 122 is disposed in proximity to the lamps and sends a signal 124 to microprocessor 120 which adjusts the PWM duty cycle as needed to avoid damage to the lamps. Further, an undervoltage sensor 126 detects low voltage in the electric generating system and sends a signal 128 to the microprocessor 120 to adjust the PWM duty cycle to maintain a desired color temperature of lamp output.

Referring to FIG. 10, a preferred embodiment 200 of an overall control function for a motorcycle headlight system uses an all digital, low-parts-count, microprocessor control based circuit. A microprocessor controller 120 is an ideal logic level, variable width pulse generator with an internal time base. It provides straightforward interface to logic level Field Effect Transistor (FET) switches 116, 118 to control the halogen lamps and offers design flexibility to accommodate optional additional functions, for example, flash control for optional integral turn signal lamps which may be embedded in the headlight assembly.

A microprocessor controller in accordance with the invention preferably operates under a resident firmware program to execute the control function steps as internally clocked at the rate governed by the R1, C1 pair setting the internal master clock. The processor operation counts down the master clock to a program controlled number of clock cycles and then toggles the control lines to the Q1 and Q2 switches 116, 118 and continually repeats this process. In this way, a control waveform of on and off states is generated many hundreds of times per second to achieve flicker free, PWM control of lamp brightness and thermal power to be dissipated.

The ratio of on time to off time, or duty cycle of the control waveform, is continually updated under program control by simply adjusting the number of clock cycles to be counted down. At the start of each repetitive count down cycle, U1 microprocessor 120 executes a read of the digital number available at the U2 and U5 analog to digital (A/D) converters. These devices generate a digital word proportional to the voltage present at their input pins and serially send this word to U1 microprocessor 120 over the Data Out (DO) line when commanded by the states of the Chip Select(CS) and Clock(CLK) lines. U1 microprocessor 120 uses these digital words under program control to either add to or subtract from the on time count and proceeds with the PWIM control waveform generation. Timing associated with the read of the U2 and US A/D's is kept very short compared to the PWM waveform generation cycle such that the processor is spending the vast majority of the time simply counting down clock cycles to toggle the Q1 and Q2 control lines from on to off.

Temperature control of the headlight assembly is achieved by creating a temperature dependant voltage at the input of the U2 A/D converter. The VR1 thermistor 122 changes resistance across its sensed temperature range. By creating a voltage divider circuit between VR1 and the bias resistor R2, a temperature dependant voltage can be applied to the U2 input proportional to the resistance of the VR1 thermistor. The temperature set point can be adjusted by changing the value of the Radj resistor R3. In this way, the U2 will send a digital word proportional to the temperature-dependant sensed input analog voltage when commanded by U1 microprocessor 120. When the sensed temperature is below the set point, U1 microprocessor 120 adds to the on time count, resulting in more power being applied to the lamps and more thermal power to be dissipated, resulting in a slow temperature rise internal to the assembly. When the temperature rises above the set point, U1 microprocessor 120 conversely subtracts from the on time count, resulting in less power to be dissipated and a cooling of the assembly. With the relatively long thermal time constant to heat and cool the assembly, a smooth and virtually imperceptible change in the light output level is effected to maintain the assembly at the set point temperature.

Under- and over-voltage conditions resulting from the battery state and charging system conditions can adversely impact lamp life or result in a perceptible lamp output yellowing. These conditions are controlled by the U5 A/D converter circuit. The supply voltage to the halogen lamp assembly is monitored by sensor 126 for variation above or below the nominal +12 vdc. Again, a digital word is sent by the U5 A/D converter to U1 microprocessor 120 proportional to the sensed difference above or below the nominal 12 dc supply voltage.

Sensing of the supply voltage is made by the U4 operational amplifier circuit. The U4 reference input pin (−) is held at a constant +5 vdc using the Zener diode Z1 biased with R7. The R4 and R5 pair forms a 2 to 1 divider such that the 10 to 15 vdc supply voltage will be halved to 5 to 7.5 vdc at their connection point. This 5 to 7.5 vdc level is applied to the input of U4 operational amplifier through R6. The feedback resistor R8 is selected such that the U4 will provide a DC gain of 2 to the difference in voltages between the +input and the −reference input held at the constant 5 v level. This results in a 0 to +5 vdc output level corresponding to the instantaneous level that the supply voltage is above the nominal low of 10 volts. The 0 to 5 volt sensed level is applied to the U5 A/D converter where a digital word is generated proportional to the level across the 0 to 5 volt input range. When polled by U1 microprocessor 120, this digital word is serially sent and used to adjust the on time of the PWM control signal. For supply voltages in excess of the nominal +12 vdc, the digital word is subtracted from U1 microprocessor's on time count, resulting in lower average current through the lamps and providing protection from stressing the lamps in this over voltage case.

When the battery supply voltage falls below the nominal +12 vdc, the on time of the PWM control signal is proportionally increased to provide higher average current and a brighter lamp to hold the light output at the equivalent of the nominal +12 V supply input. Timing of this sensing and correction action is fast enough to not result in perceptible change in light output. In this way the halogen lamps are protected from potential over-voltage stress, and the annoying yellowing of the headlight color temperature is eliminated under under-voltage conditions.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A headlamp system for a motorcycle comprising:
a) at least one high-intensity halogen lamp; and
b) means for energizing and controlling said lamp, said means including a microprocessor for controlling the duty cycle of a wave-form generator for powering said lamp by pulse width modulation in a duty cycle range between about 5% and about 95%, and means for varying said duty cycle as a function of temperature adjacent said lamp and as a function of voltage supplied to said lamp to maintain the output of said lamp at a substantially constant brightness.

2. A headlamp system in accordance with claim 1 comprising at least one high-intensity halogen lamp for high-beam use and at least one high-intensity halogen lamp for low-beam use.

3. A headlamp system in accordance with claim 1 further comprising a housing for receiving and protecting said lamp and said means for energizing and controlling said lamp.

4. A headlamp system in accordance with claim 3 wherein said housing is a portion of a triple tree crossmember for a motorcycle.

5. A triple tree crossmember for a motorcycle, said crossmember comprising a headlamp system including at least one high-intensity halogen lamp and means for energizing and controlling said lamp, said means including a microprocessor for controlling the duty cycle of a wave-form generator for powering said lamp by pulse width modulation in a duty cycle range between about 5% and about 95%, and means for varying said duty cycle as a function of temperature adjacent said lamp and as a function of voltage supplied to said lamp to maintain the output of said lamp at a substantially constant brightness.

6. A triple tree crossmember in accordance with claim 5 wherein said halogen lamp and said means for energizing and controlling are contained within said triple tree crossmember.

7. A motorcycle comprising:
a) a pivot post;
b) first and second steering forks for retaining and turning a wheel of said motorcycle; and
c) at least one triple tree crossmember pivotable on said pivot post and receivable of said steering forks,
wherein said triple tree crossmember contains a headlamp system for said motorcycle including at least one high-intensity halogen lamp and means for energizing and controlling said lamp, said means including a microprocessor for controlling the duty cycle of a wave-form generator for powering said lamp by pulse width modulation in a duty cycle range between about 5% and about 95%, and means for varying said duty cycle as a function of temperature adjacent said lamp and as a function of voltage supplied to said lamp to maintain the output of said lamp at a substantially constant brightness.

8. A method for controlling output of a high-intensity halogen lamp, comprising the steps of:
a) providing a waveform generator for generating an output wave form for powering said lamp;
b) providing a modulatable pulse width duty cycle for said output wave form;
c) providing an aim operating temperature for said halogen lamp;
d) monitoring the actual operating temperature of said halogen lamp; and
e) modulating said pulse width duty cycle in response to variations in said actual operating temperature to maintain said aim operating temperature.

9. A method in accordance with claim 8 further comprising the steps of:
a) providing an aim operating brightness for said halogen lamp at a nominal input voltage;
b) monitoring the actual input voltage; and
c) modulating said pulse width duty cycle in response to variations in said actual input voltage to maintain said aim operating brightness.
